(19) United States
(12) Patent Application Publication
(10) Pub. No.: US 2009/0087272 A1
(43) Pub. Date: Apr. 2, 2009

(54) CARPENTER DRILL PLATE

(76) Inventor: Fernando M. Hernandez, Wichita Falls, TX (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/905,346

(22) Filed: Sep. 28, 2007

(51) Int. Cl. B23B 45/14

(52) U.S. Cl. 408/112

(57) ABSTRACT

The carpenter drill plate is a 6″×11″ aluminum plate with a U-shaped handle provided on one end of the aluminum plate and secured by mounting nuts and bolts. A five-inch pipe mounted in the middle of the aluminum plate for an anchor bolt and a two-inch pipe is mounted on a second end of said aluminum plate for supporting a drill bit. A tension spring is provided between the two-inch pipe and a collar adjacent the end of the drill bit for returning the drill bit back into the two-inch pipe.

### BACKGROUND OF THE INVENTION

1. Field of the Invention

The present invention relates to drilling guides, and more particularly to a carpenter drill plate for drilling plates for anchor bolts.

2. Description of the Related Art

Portable drill guides are known that use a compression spring acting in opposition to applied downward force and includes a handle for stabilizing the device when in use. Many of the related art devices require specially designed drills that require a suitable clamp or fastening means in association with the drill to secure the drill for movement with the guide. When inserting anchor bolts, pencil measuring to center anchor bolts results in measuring errors. Using the method of measuring for single and dual drill plates is time consuming and imprecise.

Thus, a carpenter drill plate solving the aforementioned problem is desired.

### SUMMARY OF THE INVENTION

The carpenter drill plate is an aluminum plate measuring, e.g., about 6″×11″. The plate has a handle on one end for a secure grip while anchoring bolts. The opposite end has a metal pipe in the center for the anchor bolt. The other end of the tool has a 2″ pipe that drives the drill bit. The end of the tool also contains two metal bearings. The drill plate will eliminate measuring errors when inserting anchor bolts. The plate will also eliminate pencil measuring to center anchor bolts, which oftentimes results in error.

These and other features of the present invention will become readily apparent upon further review of the following specification and drawings.

### BRIEF DESCRIPTION OF THE DRAWINGS

FIG. 1 is an environmental, perspective view of a carpenter drill plate according to the present invention.

FIG. 2 is a perspective view of the top of the carpenter drill plate according to the present invention.

FIG. 3 is a perspective view of the bottom of the carpenter drill plate according to the present invention.

FIG. 4 is a perspective view of the carpenter drill plate being used to drill dual 2″×4″ and a 2″×6″ plates according to the invention.

Similar reference characters denote corresponding features consistently throughout the attached drawings.

### DETAILED DESCRIPTION OF THE PREFERRED EMBODIMENT

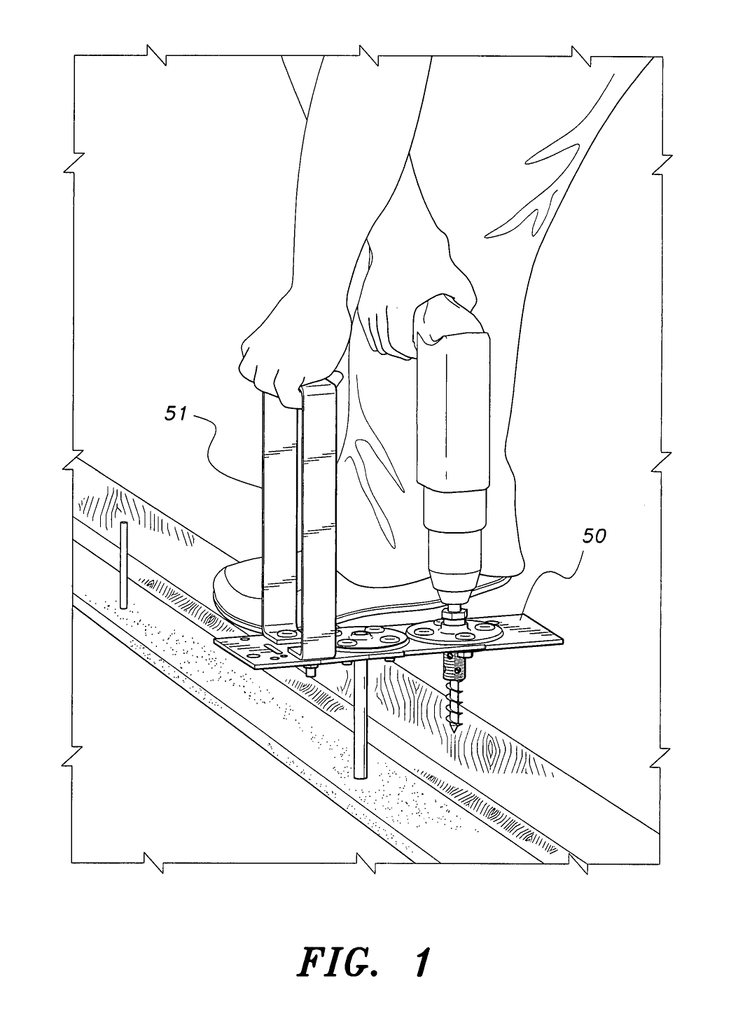

The present invention is a carpenter drill plate that is used to make inserting anchor bolts easier and precise every time. The carpenter drill plate is a 6″×11″ aluminum plate 50. A U-shaped handle 51 is provided on one end of the plate 50 and is secured thereat by mounting means in the form of nuts and bolts, as shown in FIGS. 1-3.

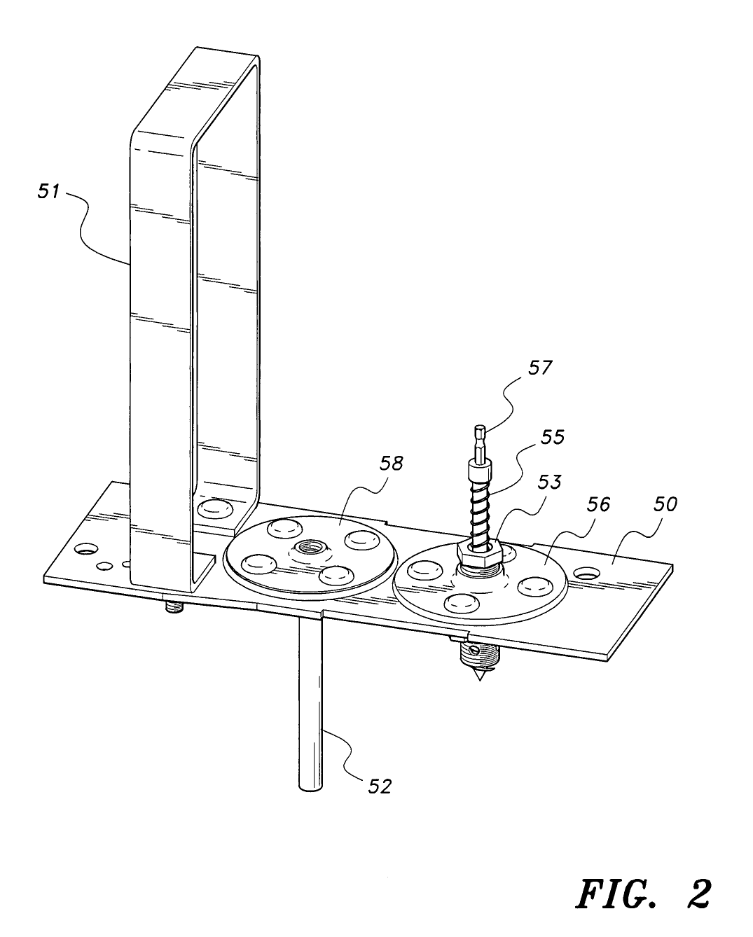

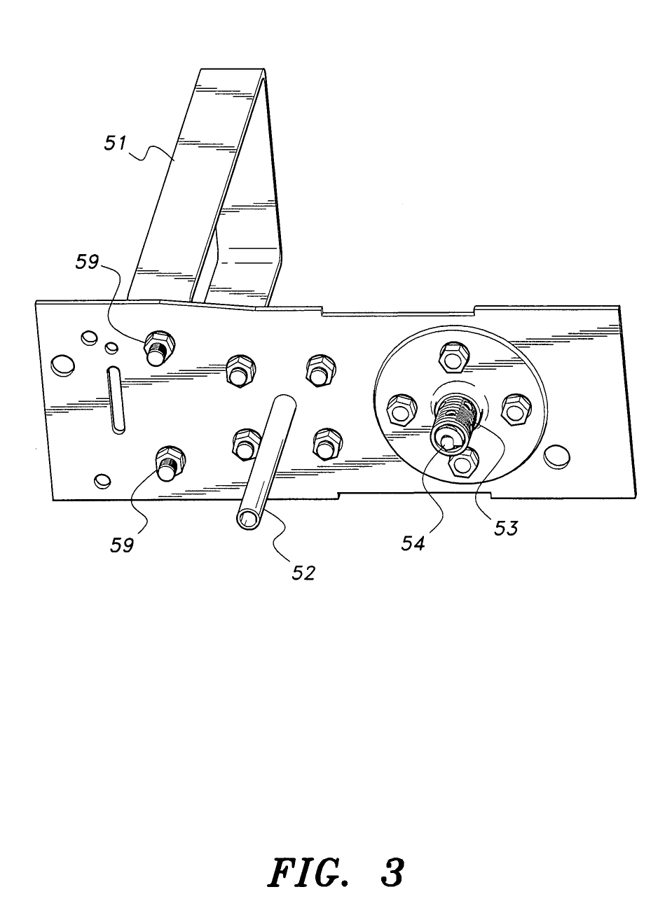

A five-inch metal pipe 52 is provided in the center of the aluminum plate 50 for the anchor bolt. As best seen in FIGS. 2 and 3, the metal pipe 52 is secured to the aluminum plate 50 by nuts and bolts through a flange 58. The other end of the aluminum measuring plate 50 is provided with a 2-inch pipe 53 that contains the drill bit 54. Two metal bearings (not shown) rotatably support the drill bit 54 in the 2-inch pipe 53. The bearings are housed in upper and lower flanges that are secured to the aluminum plate 50 by nuts and bolts.

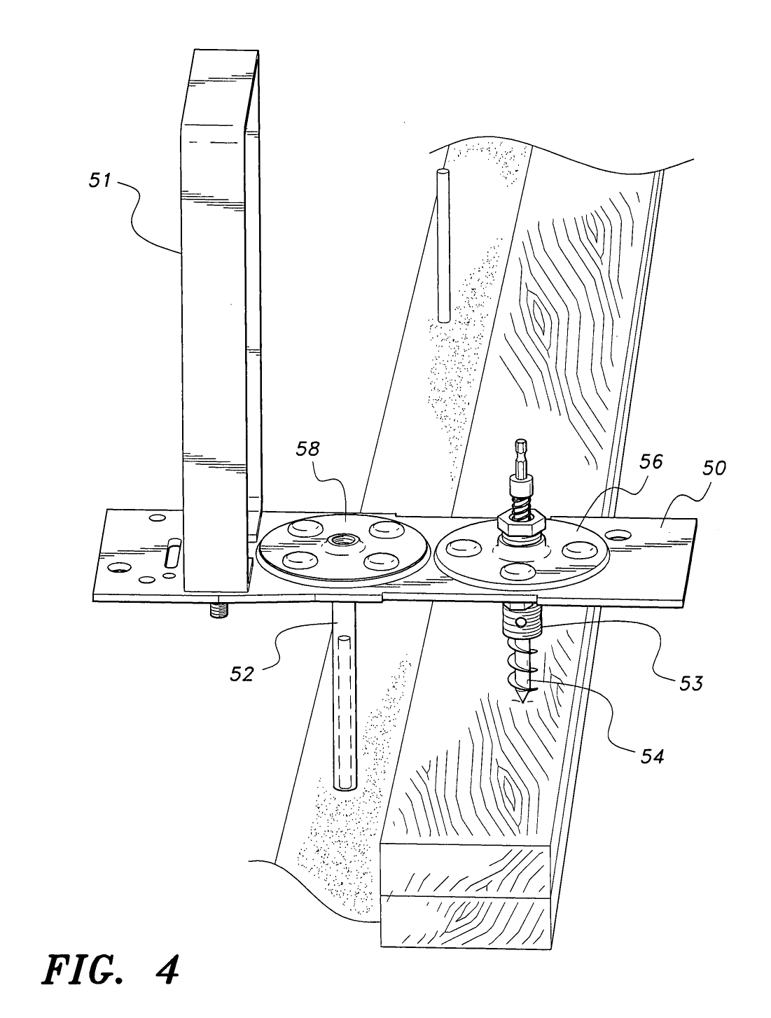

FIGS. 2 and 4 show that a tension spring 55 is provided between the pipe 53 and a collar 56 adjacent the end of the drill bit 54 for returning the drill bit 54 back into the 2-inch pipe 53. The chuck of the drill can be secured to the top 57 of the drill bit 54.

It is to be understood that the present invention is not limited to the embodiment described above, but encompasses any and all embodiments within the scope of the following claims.

I claim:

1. A carpenter drill plate, comprising:
an aluminum plate;
a U-shaped handle on one end of the aluminum plate;
a first pipe mounted in the middle of the aluminum plate for an anchor bolt; and
a second pipe mounted on a second end of the aluminum plate for supporting a drill bit.

2. The carpenter drill plate according to claim 1, further comprising: a tension spring positioned between said second pipe and a collar on said drill bit.

3. The carpenter drill plate according to claim 1, wherein said second pipe is affixed to said drill plate using a pair of flanges having bearings.
